(19) United States
(12) Patent Application Publication
(10) Pub. No.: US 2024/0394862 A1
(43) Pub. Date: Nov. 28, 2024

(54) ELECTRONIC DEVICE AND METHOD FOR IMPROVING QUALITY OF IMAGE

(71) Applicant: SAMSUNG ELECTRONICS CO., LTD., Suwon-si (KR)

(72) Inventors: Kisuk SUNG, Suwon-si (KR); Saetek OH, Suwon-si (KR); Jaehyeok CHOI, Suwon-si (KR); Inyong SHIM, Suwon-si (KR)

(21) Appl. No.: 18/786,346

(22) Filed: Jul. 26, 2024

Related U.S. Application Data
(63) Continuation of application No. PCT/KR2023/001163, filed on Jan. 26, 2023.

(30) Foreign Application Priority Data
Jan. 28, 2022 (KR) 10-2022-0013663
Feb. 8, 2022 (KR) 10-2022-0016048

(51) Int. Cl. G06T 7/00; G06T 5/20; G06T 7/11; G06T 7/246; G06T 7/90; G06V 10/26; G06V 20/50; H04N 23/80

(52) U.S. Cl. CPC G06T 7/0002; G06T 5/20; G06T 7/11; G06T 7/246; G06T 7/90; G06V 10/26; G06V 20/50; G06T 2207/10024; G06T 2207/20021; G06T 2207/20084; G06T 2207/30168; H04N 23/80

(57) ABSTRACT

An electronic device according to various embodiments includes a camera and a processor. The processor includes image processing and segmentation modules. The segmentation module generates segmentation information by segmenting an original image acquired through the camera. The processor confirms segmented areas of objects sorted from the original image using the original image delivered from the camera and the segmentation information, calculates a quality control value for each object based on an object color of a segmented area, performs primary image processing based on the calculated quality control value for each object, calculates a weighted value for each object by analyzing primary image processing results, calculates a final quality control value for the original image based on the quality control value for each object and the weighted value and delivers the final quality control value to the image processing module.

### CROSS-REFERENCE TO RELATED APPLICATIONS

This application is a continuation application, claiming priority under § 365 (c), of International Application No. PCT/KR2023/001163 filed on Jan. 26, 2023, which is based on and claims the benefit of Korean patent application number 10-2022-0016048 filed on Feb. 8, 2022, in the Korean Intellectual Property Office and of Korean patent application number 10-2022-0013663 filed on Jan. 28, 2022, in the Korean Intellectual Property Office, the disclosures of which are incorporated by reference herein in their entireties.

### TECHNICAL FIELD

Various embodiments relate to an electronic device and a method for improving image quality using segmentation information.

### BACKGROUND ART

An electronic device including a camera may process an image that is acquired via the camera by using an image signal processor (ISP).

The image signal processor may process the image by using an image quality improvement algorithm or may execute processing to provide the image with an improved image quality. The image signal processor may perform various processing operations, such as white balance (WB) adjustment, color adjustment (e.g., color matrix, color correction, and color enhancement), color filter array interpolation, noise reduction processing, sharpening, image enhancement (e.g., high dynamic range (HDR)), or face detection. The image output from the image signal processor may be a compressed image, and the compressed image may be stored in the electronic device.

Image segmentation refers to receiving an image (a training image or a test image) as an input and generating a label image as an output. Recently, as deep learning technology has been in the spotlight, research on utilizing image segmentation in camera technology to improve camera performance of electronic devices is increasing.

### DISCLOSURE OF INVENTION

### Technical Problem

In order to improve image quality, an image signal processor may analyze raw data of an image sensor to estimate an image quality control value (e.g., a brightness adjustment value or a white balance (WB) adjustment value) for an image scene, and may perform image optimization with the estimated image quality control value (e.g., white balance (WB) correction or color correction).

However, when analyzing raw data, it can be difficult to acquire additional information on the environment when an image is captured, so that the effect of image quality improvement may not meet expectations.

In addition, since the final output image passes through a pipeline of the image signal processor and undergoes post-processing, it may be difficult to accurately analyze the image scene only by analyzing the raw data. As a result, there may be a difference between a result of analyzing the raw data and a final image quality processing result, which may result in the effect of image quality improvement being lower than expected, or an error may occur.

According to various embodiments, the disclosure is to provide a method and a device capable of improving image quality by minimizing error in scene analysis using image segmentation information to acquire additional information on an image.

### Solution to Problem

An electronic device according to various embodiments includes a camera and a processor, wherein the processor further includes an image processing module and a segmentation module, and the segmentation module generates segmentation information by segmenting an original image acquired through the camera, and delivers the segmentation information to the image processing module, and memory storing instructions, executable by the processor, that cause the electronic device to confirm segmented areas of objects sorted from the original image using the original image delivered from the camera and the segmentation information, to calculate a quality control value for each object on the basis of an object color of a segmented area, to perform primary image processing through the image processing module on the basis of the calculated quality control value for each object, to calculate a weighted value for each object by analyzing primary image processing results, to calculate a final quality control value for the original image on the basis of the quality control value for each object and the weighted value and to deliver the final quality control value to the image processing module so that the final quality control value is reflected in secondary image processing.

A method for improving an image quality by an electronic device according to various embodiments includes receiving an original image from a camera, performing image segmentation on the original image to acquire segmentation information, identifying segmentation areas of classified objects in the original image using the segmentation information based on object colors of the segmentation areas, calculating an image quality control value for each object, performing primary image processing based on the calculated image quality control value for each object, calculating a weight for each object by analyzing primary image processing results based on the weight and the image quality control value for each object, calculating a final image quality control value for the original image and based on the final image quality control value and performing secondary image processing on the original image to generate a corrected image.

### Advantageous Effects of Invention

An electronic device according to various embodiments can acquire various analysis information by recognizing and classifying various and detailed objects in an image via image segmentation information. An electronic device according to various embodiments can acquire an image with improved image quality by performing image processing optimized for each object in consideration of complex image quality factors in one image scene.

An electronic device according to various embodiments can minimize image (or image scene environment) distortion and improve an image processing effect by pre-analyzing and feeding back image quality deterioration factors that occur during image signal processing.

### BRIEF DESCRIPTION OF DRAWINGS

FIG. 1 is a block diagram illustrating an example electronic device in a network environment according to one or more embodiments.

FIG. 2 is a block diagram illustrating the camera module according to various embodiments.

FIG. 3a is a block diagram for general image processing.

FIG. 3b illustrates a general face detection processing image.

FIG. 4 illustrates a block diagram of an electronic device configured to improve an image quality according to various embodiments.

FIG. 5 illustrates an original image generated by a camera and segmentation information.

FIG. 6A illustrates a method for improving an image quality according to various embodiments.

FIG. 6B illustrates specific operations of an object color reliability determination operation of FIG. 6A.

FIG. 7 illustrates an example of an operation of calculating an image quality control value of an object by using segmentation information according to an embodiment.

FIG. 8 illustrates an example of an operation of calculating a white balance (WB) control value by using segmentation information according to an embodiment.

FIG. 9 illustrates a method for improving an image quality according to various embodiments.

### MODE FOR THE INVENTION

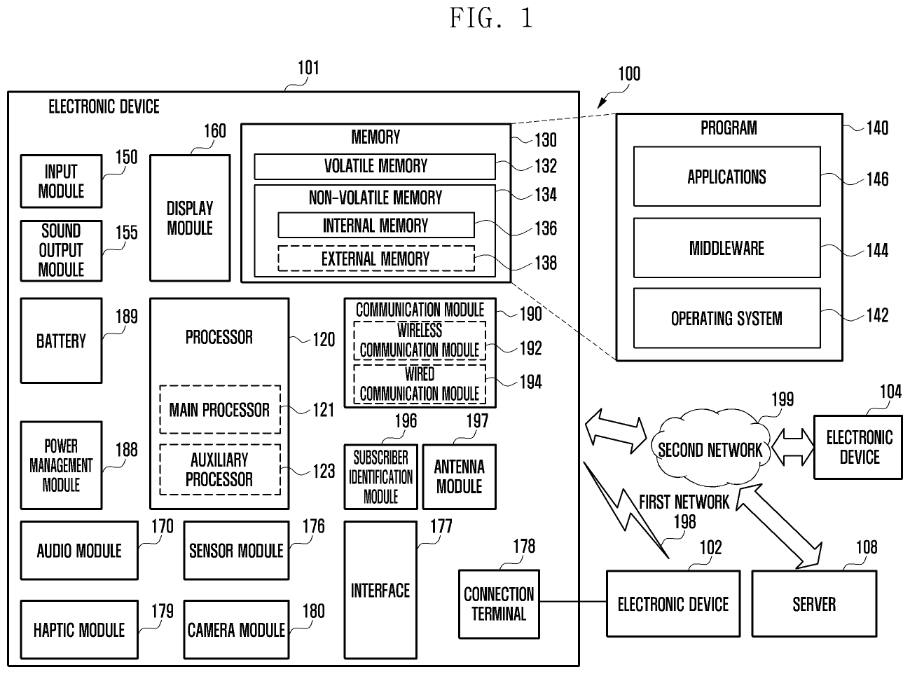

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 comprises at least one processing circuitry and may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The memory 130 may store instructions executable by the processor 120 or the electronic device 101.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module (or display) 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 comprises at least one sensor and may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connection terminal 178 may include a connector via which the electronic device 101 may be physically connected with the external electronic device (e.g., the electronic device 102). According to an embodiment, the connection terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 comprises at least one camera and may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 comprises at least one communication circuitry and may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 comprises at least one antenna and may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

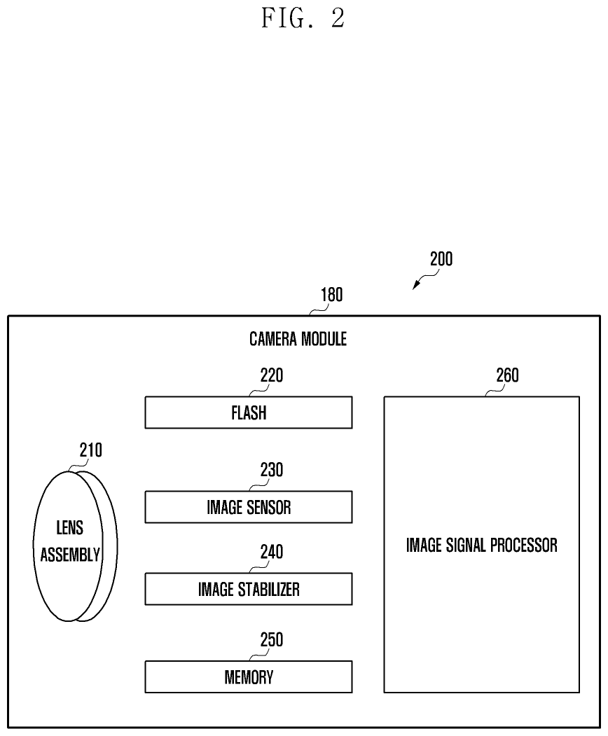

FIG. 2 is a block diagram 200 illustrating the camera module 180 according to various embodiments. Referring to FIG. 2, the camera module (or camera) 180 may include a lens assembly 210, a flash 220, an image sensor 230, an image stabilizer 240, memory 250 (e.g., buffer memory), and/or an image signal processor 260. The lens assembly 210 may collect light emitted or reflected from an object whose image is to be taken. The lens assembly 210 may include one or more lenses. According to an embodiment, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each one of the plurality of the image sensors included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows for compensating for at least part of a negative effect (e.g., image blurring) by the movement on an image being captured. According to an embodiment, the image stabilizer 240 may sense such a movement by the camera module 180 or the electronic device 101 using a gyro sensor (not shown) or an acceleration sensor (not shown) disposed inside or outside the camera module 180. According to an embodiment, the image stabilizer 240 may be implemented, for example, as an optical image stabilizer.

The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display module 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display module 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display module 160 as it is or after being further processed.

According to an embodiment, an electronic device 101 may include multiple camera modules 180, each of which has a different attribute or function. In this case, for example, at least one of the multiple camera modules 180 may be a wide-angle camera, and at least another one may be a telephoto camera. Similarly, at least one of the multiple camera modules 180 may be a front camera, and at least another camera may be a rear camera.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

Hereinafter, white balance (WB) adjustment will be described as an example of image quality improvement processing. However, the disclosure is not limited thereto, and segmentation information may be used for other image quality processing.

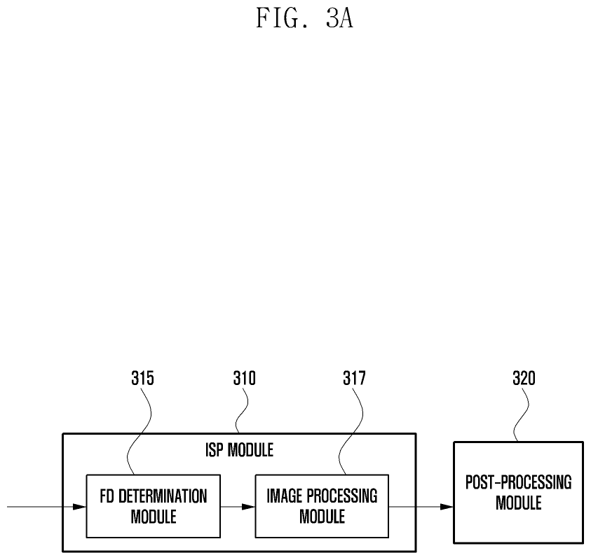

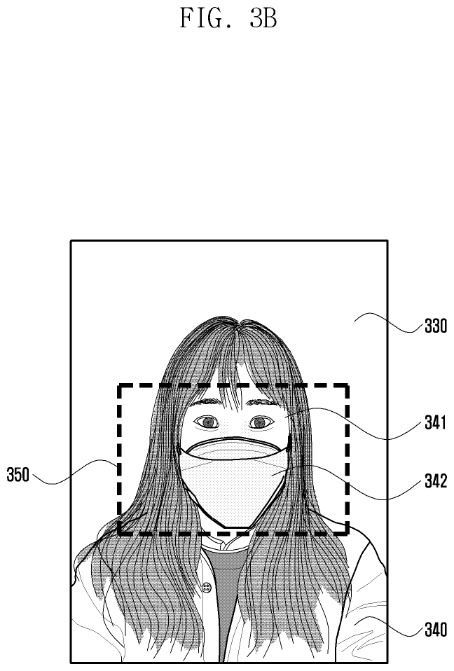

Referring to FIG. 3A, general (or conventional) image processing may be performed via an image signal processor (ISP) module (or ISP) 310 and a post-processing module 320.

The ISP module 310 may receive an original image captured by a camera. The original image (or raw data or unprocessed image data) (e.g., an image with minimal data processing in an ISP block to acquire raw stats information, such as lens shading correction (LSC) and pedestal (camera height movement)) output by the camera may include Bayer pattern data or RGB data.

The ISP module 310 may perform various image signal processing operations on the original image to generate a processed corrected image and may transfer the corrected image to the post-processing module 320. For example, the ISP module 310 may generate the corrected image while passing through an image pipeline for performing at least one of WB correction, color adjustment (e.g., color matrix, color correction, and color enhancement), color filter array interpolation, noise reduction processing, sharpening, image enhancement (e.g., high dynamic range (HDR), gamma correction, color space conversion, image compression, and image scaling on the original image.

The corrected image (or processed image data) may be transferred to the post-processing module 320 for further processing before being displayed on a display, and the image processed by the post-processing module 320 may be transferred to the display or stored in a memory.

As an example of image processing for WB correction, the ISP module (or ISP) 310 may perform WB correction on the image via a face detection (FD) determination module 315 and an image processing module (or an image pipeline) 317.

The face detection (FD) determination module 315 may determine whether a face feature exists in the image and may detect an area (or face area) including the face feature. The image processing module 317 may estimate color and brightness based on the face area transferred from the FD determination module 315, may determine a WB control value (e.g., a WB target) according to the estimated color and brightness and may generate a corrected image by correcting the WB of the image based on the WB control value.

However, when detecting a face within the original image, the general (or conventional) face detection (FD) determination module 315 detects, as illustrated in FIG. 3B, an area 350 including the face feature in the form of a designated rectangle. The FD determination module 315 transfers the rectangular face area 350 (e.g., face detection data) to the image processing module 317, so that, when the image processing module 317 estimates face color and brightness, factors other than face color (e.g., hair color and background color) contribute to determination of the face color.

Accordingly, it can be difficult for the image processing module 317 to accurately analyze face color and thus it can be likely that the image processing module 317 derives an inaccurate WB control value so that image quality improvement performance may be deteriorated even though WB correction is performed. In addition, when there is an accessory, such as a mask 342, worn on the face, there may be a difference between a result obtained by analyzing the original data and a final image quality processed result due to inaccurate color judgment so that an error may occur in color improvement.

Hereinafter, various embodiments will provide descriptions for a method and a device capable of identifying and classifying objects in an image in more detail by using segmentation information in order to improve an image processing difference which occurs due to a failure in accurately analyzing a factor for a real environment and an image processing environment while passing through an ISP pipeline and improving accuracy of a data analysis result by considering various factors that cause a difference between actual raw data and a final quality processed image to thereby improve image quality.

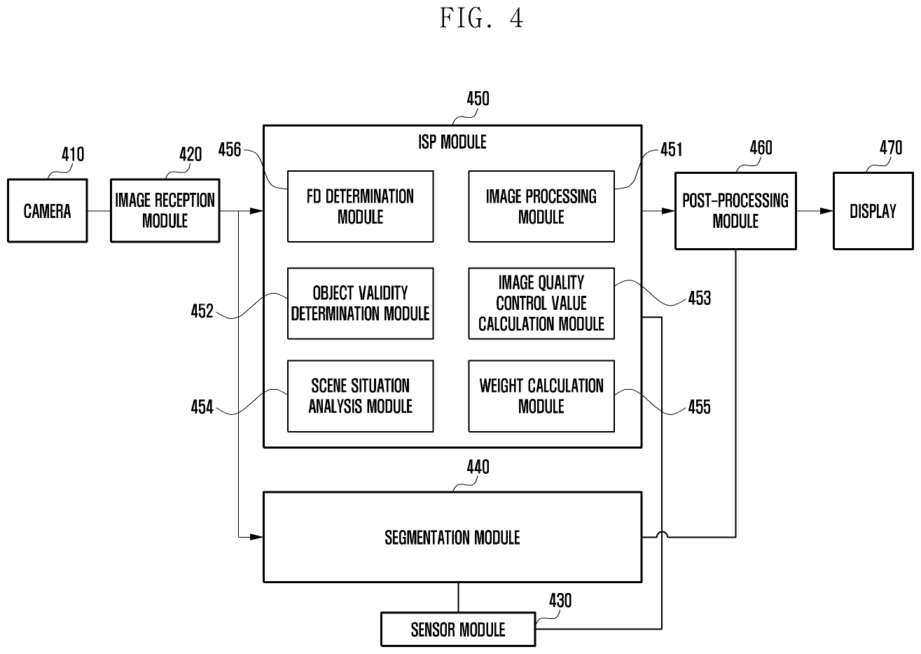

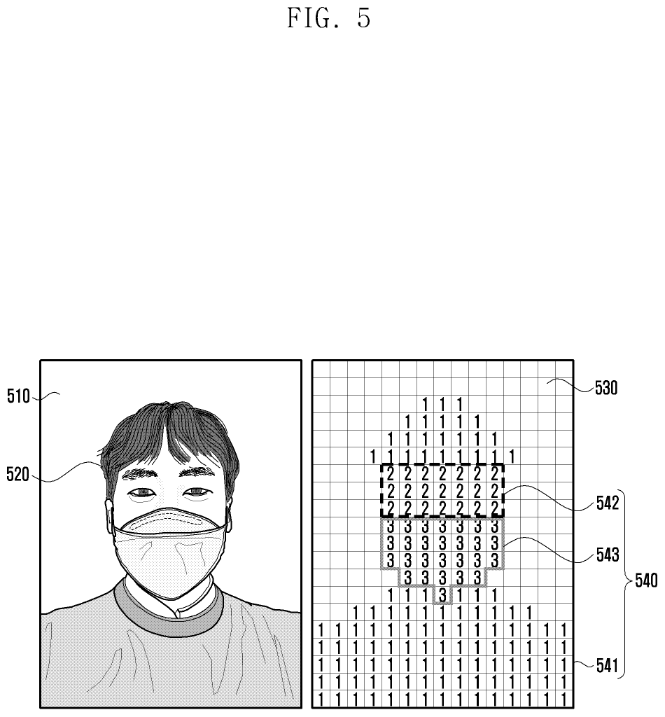

FIG. 4 illustrates a block diagram of an electronic device configured to improve an image quality according to various embodiments. FIG. 5 illustrates an original image generated by a camera and segmentation information.

Referring to FIG. 4, an electronic device (e.g., the electronic device 101 of FIG. 1) configured to improve image quality of an original image according to various embodiments may include a camera 410, an image reception module 420, a sensor module 430, a segmentation module 440, an image signal processor (ISP) module 450, a post-processing module 460, and a display 470. The elements of the electronic device 101 may be operatively or electrically connected to each other.

According to an embodiment, the segmentation module 440, the ISP module 450, and the post-processing module 460 may be program modules executed by the processor 120 of FIG. 1 or by the image signal processor 260 of FIG. 2.

According to some embodiments, the segmentation module 440 may be, but is not limited to, an element of the electronic device 101, and may be an element of an external electronic device. When the segmentation module 440 is an element of an external electronic device, operations of the segmentation module 440 may be implemented by transmitting data to and receiving data from the electronic device 101 via a communication module (e.g., the communication module 190 in FIG. 1).

According to some embodiments, the segmentation module 440 and the ISP module 450 may be implemented as a single module.

The camera 410 may acquire an image via a lens and capturing light. An image acquired via the camera 410 may have image quality deterioration due to various factors. Image processing to improve an image quality may be performed before image encoding.

The image reception module 420 may include at least one image sensor (not illustrated) that converts an optical signal transferred from the camera 410 into an electronic signal. The image sensor may generate an original image (or raw data or unprocessed image data) based on an optical signal acquired from the camera 410.

According to an embodiment, the original image output from the image sensor may include Bayer pattern data or RGB data. For example, the image sensor includes an integrated circuit having an array of pixels, where each pixel may include a light detector for detecting light. However, since the light detector is unable to detect a wavelength of captured light alone, color information cannot be determined. The image sensor may further include a color filter array (e.g., a Bayer CFA and an RGB filter) on the pixel array of the image sensor in order to capture color information. The image sensor may generate an original image including color information (e.g., Bayer pattern data and RGB data) relating to an intensity of light received via the color filter array.

The image reception module 420 may transfer the original image output from the image sensor to the ISP module 450 and the segmentation module 440. The original image transferred to the segmentation module 440 may be a copy image that is a copy of the original image.

The segmentation module 440 may acquire segmentation information by performing segmentation on the image and may transfer the segmentation information to the ISP module 450.

According to an embodiment, the segmentation module 440 may perform image segmentation (e.g., object segmentation, skin segmentation, body segmentation, background segmentation, etc.). Image segmentation may refer to dividing an image area according to certain attributes. Alternatively, image segmentation may involve one or more procedures of dividing objects in the image (or a frame corresponding to the image) into units of pixels or units of areas, assigning attribute values and recognizing and classifying (or identifying) the objects.

According to an embodiment, the segmentation module 440 may configure a segmentation map by distinguishing and recognizing (or detecting) the objects included in the image. The segmentation module 440 may classify the objects in the image based on various features, such as edges and blobs, in the image and may acquire object recognition results (or object classification information) (e.g., skin, body, mask, sky, or grass) for the objects using a recognition algorithm. The recognition algorithm may include, but not be limited to, one or more of Object recognition algorithm, faster R-CNN based feature map and Fully Convolutional Network (FCN)

According to some embodiments, the segmentation module 440 may acquire information on object attributes (e.g., a focal length, an auto focus area, right and left rotation-related information (orientation) during image capturing, a color space, an exposure time, aperture-related information (F number), an image capturing mode (exposure program) (e.g., an auto mode, an aperture mode, a shutter mode, a manual mode, etc.), ISO (ISO speed ratings), an image capturing date (data time original), or the like) using the object recognition results and/or image metadata (e.g., color information, location analysis information, season information, and exposure-related information).

The segmentation information may include object recognition information (or object classification information) included in the image, position information (or pixel coordinate information) of recognized objects, and information on object attributes and may include all information on the objects.

The segmentation module 440 may perform segmentation based on an artificial neural network. A single artificial neural network may be used. In addition, segmentation may be performed using multiple artificial neural networks and then results thereof may be combined. For a network structure of an artificial neural network for image segmentation, various structures, such as an ENet structure, may be applied.

Image segmentation using an artificial neural network may include receiving an image and outputting object information. A form of input data (or learning data) may be an image (e.g., including multiple pixels) and output data (or labeling data) may be object recognition information (or object classification information).

According to an embodiment, when the image includes a person located at a specific location, the segmentation module 440 may recognize the person, divide an area of the person into skin, body, worn accessory (e.g., glasses or a mask) and/or a non-skin area of the face (e.g., a face painting area) and may recognize objects, such as other objects (e.g., lighting, floor, ceiling, tree, or sky) in areas (out of human) other than the area of the person.

For example, as illustrated in FIG. 5, an original image 510 may include a subject (or person) 520. The segmentation module 440 may perform segmentation on the original image 510 and configure a segmentation map 530. The segmentation module 440 may recognize a segmentation area 540 classified as a person via the segmentation map 530 and may recognize a body area 541, a skin area 542 and a mask area 543 within the segmentation area 540 classified as the person and may classify the same as respective objects. The segmentation module 440 may assign an attribute value of the body area (or body object) 541 to be 1, may assign an attribute value of the skin area (or skin object) 542 to be 2 and may assign an attribute value of the mask area (or mask object) 543 to be 3 within the segmentation area 540 classified as the person to configure the segmentation map 530.

The sensor module 430 (e.g., the sensor module 176 of FIG. 1) may generate an electrical signal or data in response to an external environmental state or an internal operation state of the electronic device 101.

The segmentation module 440 may perform motion estimation (in other words, a procedure of estimating and calculating the direction and speed of the object across multiple frame images) for movement of the subject (or object) based on sensor information transferred from the sensor module 430.

The segmentation module 440 may calculate a processing time for performing segmentation and a delay time (e.g., a delay rate per frame) that occurs while processing the image in units of frames. The segmentation module 440 may adjust the segmentation map (or map boundary part) based on delay data (or delay time) reflecting object movement in an image processing module 451. For example, the segmentation module 440 may adjust (add or delete an area classified as an object) a boundary part of an object position.

For example, frames of the image (or frames corresponding to the image) captured by the camera may be acquired at regular time intervals and a difference may occur between a time at which frame images are processed in the image processing module 451 and a time at which segmentation is performed. In this case, when the image is analyzed close to a final result of ISP processing, a more accurate analysis result is derived so that the segmentation module 440 may predict movement of the segmentation map according to subject movement to derive accurate analysis of an image scene.

According to an embodiment, the segmentation module 440 may transfer data related to subject movement information (e.g., direction and speed) and a delay time (or delay value) so that segmentation information is fed back and reflected in the image being processed via the image processing module 451 (or processing blocks of respective ISP pipelines).

The ISP module 450 may generate a corrected image via various image processing while passing the original image, which is transferred from the image reception module 420, through the image processing module (or ISP pipeline processing block), and may store the corrected image in the memory or transfer the same on the display.

As an example, the ISP module 450 may lower a resolution of the original image received from the camera 410 and display the original image on the display. The ISP module 450 may encode an image format into a lossy compression format (e.g., YUV or JPEG) and store the same in the memory (not illustrated).

Image processing performed via the image processing module (or ISP pipeline) 451 may include at least one among, for example, defective pixel detection/correction, WB correction, color adjustment (e.g., color matrix, color correction, and color enhancement), color filter array interpolation, noise reduction processing, sharpening, image enhancement (e.g., high dynamic range (HDR), gamma correction, color space conversion, image compression, and image scaling operations.

According to an embodiment, the ISP module 450 may receive segmentation information from the segmentation module 440 and perform image processing using the segmentation information. For example, the ISP module 450 may include the image processing module 451, an object validity determination module 452, an image quality control value calculation module 453, a scene situation analysis module 454, a weight calculation module 455 and an FD determination module 456.

According to some embodiments, the FD determination module 456 may be omitted.

The image processing module (e.g., ISP pipeline) 451 may perform overall image processing related to the image signal processor module, based on data calculated from the object validity determination module 452, the image quality control value calculation module 453, the scene situation analysis module 454, the weight calculation module 455 and the FD determination module 456.

The image processing module (e.g., ISP pipeline) 451 may process image data in a color space as well as in the original image (or raw data).

Image processing performed by the image processing module (e.g., ISP pipeline) 451 may vary, but for convenience of description, WB adjustment will be used as an example to improve an image quality. In addition, the image processing module (e.g., ISP pipeline) may perform image processing, such as color adjustment (e.g., color matrix, color correction, and color enhancement) and image enhancement (e.g., high dynamic range (HDR)), by using the segmentation information.

According to an embodiment, the data calculated by the object validity determination module 452, the image quality control value calculation module 453, the scene situation analysis module 454, the weight calculation module 455, and the FD determination module 456 may be implemented to be provided (or fed back) to the image processing module (e.g., ISP pipeline) 451.

For example, when image processing in units of image frames is assumed, it may be understood that the image processing module (e.g., ISP pipeline) 451 performs image quality processing on a first frame of the image, and then, from a second frame, image quality processing is performed according to results of analyzing the original data and the data calculated by the object validity determination module 452, the image quality control value calculation module 453, the scene situation analysis module 454, the weight calculation module 455, and the FD determination module 456.

The object validity determination module 452 may identify segmentation areas of the classified objects in the original image using the segmentation information and may analyze whether the recognized objects are valid as image processing objects and determine the reliability of object colors (or color accuracy) based on the original image and the segmentation information of the image.

According to an embodiment, the object validity determination module 452 may convert pixel data of a segmentation area, in which a target object (e.g., skin object) is located, into color tone values of a hue-saturation-and-value (HSV) color space based on the segmentation information of the objects recognized in the image and may determine an object color (or color temperature) by identifying distribution of minimum, maximum and average values based on a color histogram. The color space may include at least one of HSV, HSU, YUV, HLS, Lab, and YCM.

For example, when an object with a skin color is recognized for WB correction, the object validity determination module 452 may determine whether the object with the skin color is valid as a face color of a person.

When the object is analyzed as a valid object, the object validity determination module 452 may estimate the reliability of the object color by comparing color information included in the original data with the object color (e.g., the color of the segmentation area of the object) analyzed via the segmentation information.

When compared to the object color in the original image, if the reliability (or color accuracy) of the object color in the segmentation information is greater than or equal to a designated first value (e.g., a largest value) (or if the reliability is high), the object validity determination module 452 may determine the object color of the segmentation information to be the color of the object. If the object color in the segmentation information is then found to have a value smaller than or equal to a designated second value (e.g., a smallest value) (or if the reliability is low), the object validity determination module 452 may designate an object color acquired by analyzing a similar environment related to a scene of the image or an object color of another similar object in the image as the color of the object.

Alternatively, if the reliability (or color accuracy) of the object color in the segmentation information is found to be between the first value (e.g., the largest value) and the second value (e.g., the smallest value), the object validity determination module 452 may mix the color of the segmentation information and the color of the original image and designate the mixed color as the color of the object.

According to some embodiments, the image quality control value calculation module 453 may adjust an image quality control value of the object by using the reliability of the object estimated by the object validity determination module 452.

According to some embodiments, the FD determination module 456 may detect a rectangular area including a face feature as a face area. The object validity determination module 452 may detect an area (an area along the contour line) with the skin color in the face via the segmentation information as well as color information of the face area as the face and may calculate the color and brightness of the face area more precisely and accurately by combining face detection data acquired from the FD determination module 456.

According to some embodiments, the segmentation module 440 may be placed after the ISP module 450 or the post-processing module 460. In this case, the ISP module 450 or the post-processing module 460 may acquire an image with an image quality almost similar to a final image quality via the segmentation information before image processing and may thus calculate more accurate color and brightness of the face area. According to some additional embodiments, multiple segmentation modules 440 can be provided, with one or more segmentation modules 440 provided upstream from the ISP module 450 and/or in parallel with the ISP module 450 and with one or more segmentation modules 440 provided downstream from the ISP module 450 and/or with one or more segmentation modules 440 provided downstream from the ISP module 450 and the post-processing module 460.

The image quality control value calculation module 453 may calculate an image quality control value (e.g., gain calculation for WB correction, gain calculation for color adjustment (RGB processing), or color correction matrix (CCM) coefficients), based on the segmentation information and configuration values during image processing, such as automatic exposure, automatic WB, auto focus, flicker detection, and black level compensation, and may transfer the calculated image quality control value to the image processing module 451.

The image quality control values may include at least one of a WB correction value, a color adjustment value, a color filter correction value, an automatic exposure correction value, a noise adjustment value, a texture adjustment value and a tone curve value.

According to an embodiment, the image quality control value calculation module 453 may calculate an image quality control value for each object included in the image.

For example, for WB correction, the image quality control value calculation module 453 may calculate WB image quality control values (e.g., a WB target of face skin and a WB target of a lighting object) for each object corresponding to a white area.

The image processing module 451 may perform pipeline processing operations based on the image quality control values transferred from the image quality control value calculation module 453. Based on the transferred image quality control values, the image processing module 451 may transfer results of the processed image pipeline operations to the weight calculation module 455.

The weight calculation module 455 may calculate a weight for correction according to results of image processing on an object area and image processing on an out-of-object area based on the segmentation information and may adjust correction gain (e.g., WB gain) for each object according to the weight.

The weight calculation module 455 may determine a weight for each object based on at least one of object brightness information, object color (color temperature) information, object movement information (e.g., speed and movement), object color reliability, distance information, size information, a segmentation ratio and weight information for each object segmentation area within the image.

According to some embodiments, the scene situation analysis module 454 may analyze a situation for a scene of the image and transfer analysis information to the weight calculation module 455. For example, the scene situation analysis module 454 may acquire environmental information by analyzing situations, such as whether a place at which the object in the image is located is indoor place or outdoor, whether it is a night environment, a dark environment and an ocean environment whether lighting is present, and the color temperature of the lighting.

According to some embodiments, the image quality control value calculation module 453 may adjust image quality control values based on analysis information obtained by analyzing the environmental information and result data obtained by image processing using the image quality control values (control parameters).

The weight calculation module 455 may mix the image quality control values and weight for each object to calculate a final image quality control value (e.g., final target) that reflects various factors occurring during image processing (e.g., ISP pipeline).

The weight calculation module 455 may provide the final image quality control value to the image processing module (ISP pipeline) 451 so that the final image quality control value is fed back during image processing by the image processing module 451.

The image processing module (ISP pipeline) 451 may generate a final result of the image processing module 451 (in other words, a corrected image) based on the final image quality control value and may then transfer the corrected image to the post-processing module 460.

The post-processing module 460 may receive the corrected image output from the image processing module 451 of the ISP module 450 and may perform post-processing on the received corrected image. For example, the post-processing module 460 may perform dynamic range compression, as well as luminance, contrast and color adjustment for image data and scaling to scale the size or resolution of the image data based on a resolution of the display 470.

The post-processing module 460 may transmit the post-processed image to the display 470 to display the image being captured. Alternatively, the post-processing module 460 may store the post-processed image in the memory (not illustrated).

An electronic device (e.g., the electronic device 101 of FIG. 1) according to various embodiments may include a camera (e.g., the camera module 180 of FIG. 1 and FIG. 2 and the camera 410 of FIG. 4) and a processor (e.g., the processor 120 of FIG. 1, the image signal processor 260 of FIG. 2, and the ISP module 450 of FIG. 4), wherein the processor further includes an image processing module (e.g., the image processing module 451 of FIG. 4) and a segmentation module (e.g., the segmentation module 440 of FIG. 4). In these or other cases, the segmentation module 440 is configured to generate segmentation information by performing segmentation on an original image acquired via the camera 410 and is further configured to transfer the segmentation information to the image processing module 451. the electronic device may include memory storing instructions, executable by the processor, that cause the electronic device to identify segmentation areas of classified objects in the original image using the original image transferred from the camera 410 and the segmentation information and is further configured to calculate an image quality control value for each object based on object colors of the segmentation areas, to perform primary image processing based on the calculated image quality control value for each object via the image processing module 451, to calculate a weight for each object by analyzing primary image processing results, to calculate a final image quality control value for the original image based on the weight and the image quality control value for each object and to transfer the final image quality control value to the image processing module 451 so that the final image quality control value is reflected in secondary image processing.

The image processing module 451 according to various embodiments may include image signal pipeline.

The electronic device 101 according to various embodiments may further include a sensor module (e.g., the sensor module 176 of FIG. 1) and the segmentation module may be further configured to perform image segmentation to classify objects recognized in the original image and may be further configured to effectively configure a segmentation map, to perform object motion estimation based on sensor information acquired from the sensor module 176 to calculate delay data between a segmentation performance time and a time required for image processing in the image processing module and to adjust the segmentation map based on the delay data.

The segmentation map according to various embodiments may be configured based on original data of the original image acquired from the camera 410 or based on data processed by passing the original data through at least a part of an image signal processor pipeline included in the image processing module 451.

The processor 120 or the ISP module 450 according to various embodiments may be further configured to determine the object colors according to the segmentation areas of the objects, to determine whether an object identified in the image is valid as an object for image processing based on the object colors and to calculate an image quality control value of the object when the identified object is valid as an object for image processing.

The processor 120 or the ISP module 450 according to various embodiments may be further configured to change pixel data of a segmentation area of the object in the segmentation map to color space data when an object identified via the segmentation information is valid as an object for image processing, to determine a color or color temperature of the object, to estimate the reliability of the object color by comparison with a color of an area in which the object is located in the original data and to calculate an image quality control value of the object based on the determined object color by using the reliability.

The processor 120 or the ISP module 450 according to various embodiments may be further configured to determine the object color of the segmentation information to be the color of the object if the reliability of the object color in the segmentation information is equal to or greater than a designated first value when compared to the object color in the original image, to designate an object color acquired by analyzing a similar environment related to a scene of the image or an object color of another similar object in the image as the color of the object if the reliability of the object color in the segmentation information is equal to or smaller than a designated second value and to designate the color of the object by mixing the object colors in the segmentation information and the original image if the reliability of the object color in the segmentation information is between the first value and the second value.

The processor 120 or the ISP module 450 according to various embodiments may be configured to perform the primary image processing including a first operation of image processing on a segmentation area of a first object among the objects, a second operation of image processing on a segmentation area of a second object and a third operation of image processing on an area other than the segmentation areas classified as the objects.

The processor 120 or the ISP module 450 according to various embodiments may be further configured to determine a weight for each object after the primary image processing based on at least one of object brightness information, object color information, object color temperature information, object movement information, object color reliability, distance information, size information, a segmentation ratio and weight information for each object segmentation area within the image.

The processor 120 or the ISP module 450 according to various embodiments may be further configured to analyze a scene situation of the image based on result data of the primary image processing and to adjust the weight according to an analysis result.

The processor 120 or the ISP module 450 according to various embodiments may be configured to calculate an image quality control value differently in response to image processing determined for each object when different image processing is performed for each object classified based on the segmentation information and to apply the same to image processing.

The processor 120 or the ISP module 450 according to various embodiments may be further configured to generate a corrected image by performing the secondary image processing based on the final image quality control value and to post-process the corrected image to either display the same on the display or store the same in a memory.

The image quality control value according to various embodiments may include at least one of a WB correction value, a color adjustment value, a color filter correction value, an automatic exposure correction value, a noise adjustment value, a texture adjustment value and a tone curve value.

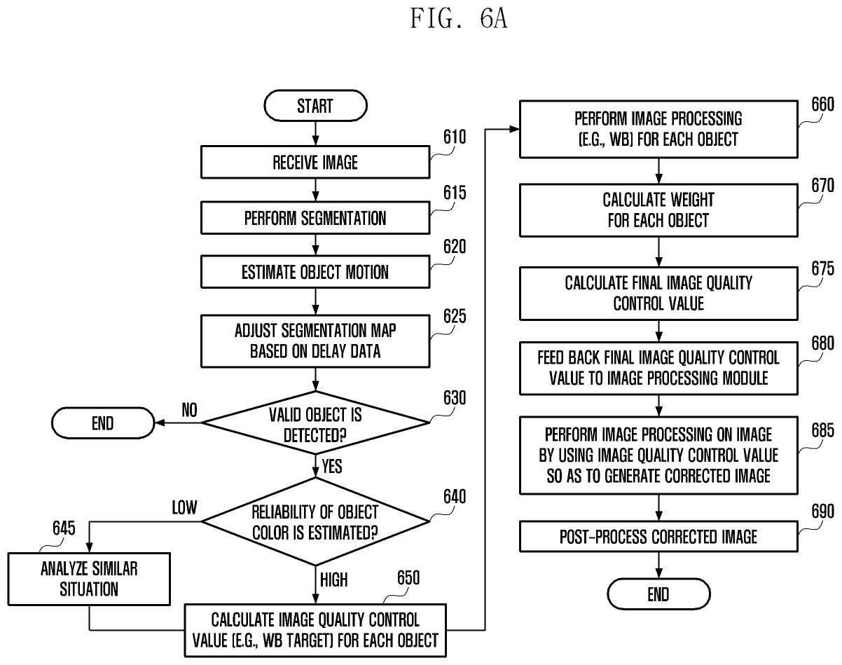

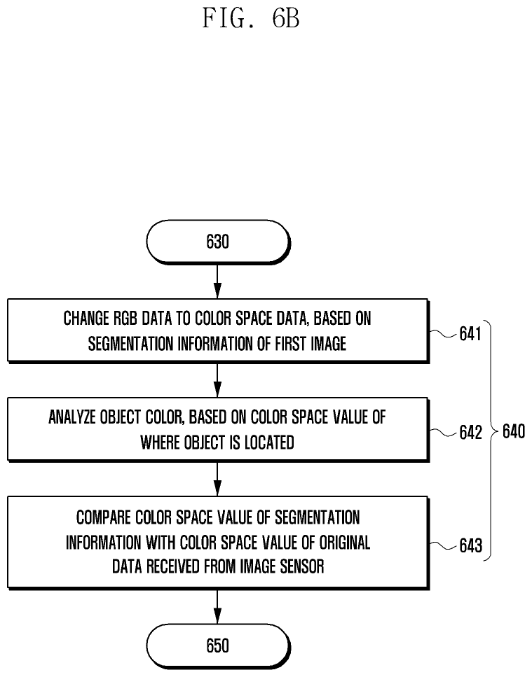

FIG. 6A illustrates a method for improving an image quality according to various embodiments and FIG. 6B illustrates specific operations of an object color reliability determination operation of FIG. 6A.

In operation 610, a processor (e.g., the processor 120 of FIG. 1, the image signal processor 260 of FIG. 2, and the ISP module 450 of FIG. 4) of an electronic device according to various embodiments may receive an original image from a camera. The original image (or raw data or raw image data) may include Bayer pattern data or RGB data.

In operation 615, the processor 120 may perform segmentation on the original image.

For example, the processor 120 may control a segmentation module to perform segmentation on the original image and acquire segmentation information of the image.

For example, the processor 120 may configure a segmentation map by performing image segmentation and may classify objects recognized in the image to acquire object segmentation areas and object classification information (and object attribute information).

For example, if there is a person wearing a mask in the image, the processor 120 may acquire object attribute information, such as “a person wearing a mask is located in an indoor area (e.g., the presence of lighting), white person, long hair, and white mask”, and position information (e.g., pixel coordinate information) of the area in which the person in the image is located as segmentation information.

In operation 620, the processor 120 may perform motion estimation to detect object movement in the image.

For example, the processor 120 may perform motion estimation (in other words, a procedure of calculating object movement across multiple frame images) of an object (or subject) included in continuous images (e.g., multiple frame images).

The processor 120 may predict object movement (or change information of feature points) via motion estimation.

The processor 120 may calculate a processing time for performing segmentation and a delay time (e.g., a delay rate per frame) that occurs while processing the image in units of frames.

In operation 625, the processor 120 may adjust the segmentation map according to the delay time reflecting object movement estimated via motion estimation.

For example, since there is a difference between information obtained by analyzing the original data received from the camera and information obtained by analyzing the image processed via an ISP pipeline (or post-processing), there is bound to be a difference in a final image quality processing result. For image quality processing, when an environment of the image processed via the ISP pipeline is considered, image analysis is performed in an environment similar to that of a final result, which may be effective in improving image quality processing.

Since there is a time required to process multiple frames via an image processing module, the processor 120 may adjust the segmentation map (or map boundary part) by applying the time delay according to object movement to the segmentation map configured based on initial data. For example, the processor 120 may adjust (add or delete an area classified as an object) a boundary part of an object position.

In operation 630, the processor 120 may analyze the segmentation information to determine whether valid objects are detected.

For example, the processor 120 may determine whether an object (e.g., a skin object (e.g., an area classified as having a skin color of a person) recognized from the image is valid as a face object for WB adjustment.

The processor 120 may terminate the process if the object is not valid as an object for image processing and proceed to operation 640 if the object is valid as an object for image processing.

In operation 640, the processor 120 may estimate the reliability (or color accuracy) of an object color.

According to an embodiment, to specifically describe the estimating of the reliability (or color accuracy) of the object color, the processor 120 may, as illustrated in FIG. 6B, convert RGB data of an object segmentation area into color space data (e.g., HSV data), based on the segmentation information of the image in operation 641. In operation 642, the processor 120 may determine the object color based on a color space value of the object. In operation 643, the processor 120 may estimate the reliability (or color accuracy) of the identified object color by comparing the object color space value of the segmentation information with a color space value of the original image (or raw data) received from the camera.

If the reliability of the object color in the segmentation information is equal to or greater than a designated value (or if the reliability is high) compared to the object color in the original image, the processor 120 may determine the color of the object to be the object color of the segmentation information.

In operation 645, if the reliability of the object color in the segmentation information is equal to or less than a specified value (or if the reliability is low), the processor 120 may analyze an object color of another similar object in the image or a similar environment related to a scene of the image and designate the color of the object to be a previously acquired object color.

According to some embodiments, operation 645 may be omitted.

According to some embodiments, if the reliability of the object color in the segmentation information is between the first value and the second value, the processor 120 may designate the color of the object by mixing the object colors in the segmentation information and the original image.

In operation 650, the processor 120 may calculate an image quality control value for each object based on the reliable object color.

For example, for WB adjustment, the processor 120 may calculate an image quality control value (e.g., a face object WB target value) for a face area and an image quality control value (e.g., an out-of-object WB target value) for an area other than the face among skin objects included in the image. In addition to the image quality control values described above, when there are valid objects (e.g., a sky object, a mask object, and a body object) as objects for WB adjustment, an image quality control value may be calculated for each object.

In various embodiments, an image quality control value is calculated for each object, so that, even if being classified as the same object, a different image quality control value may be calculated according to a characteristic of each object. For example, even for a black person's face, brightness, saturation, etc. of the face have different characteristics, so that an image quality control value may vary depending on saturation of a search color.

In operation 660, the processor 120 may perform image processing based on the image quality control value calculated for each object.

For example, the processor 120 may perform WB correction on the face area using the image quality control value of the face object and may perform WB correction using an area other than the face area as an image quality control value (e.g., an out-of-object WB target value) of an object other than the face.

Image processing may be performed sequentially or in parallel for respective objects (or object areas).

In operation 670, the processor 120 may calculate a weight for each object.

The processor 120 may determine a weight for each object based on at least one of object brightness information, object color (color temperature) information, object movement information (e.g., speed and movement), object color reliability, distance information, size information, a segmentation ratio and weight information for each object segmentation area within the image.

For example, the processor 120 may calculate a weight for object color correction by combining a WB gain value of the face area and a WB gain value of an area other than the face area. The processor 120 may adjust the image quality control value for each object by mixing appropriate color values according to the weight.

According to some embodiments, the processor 120 may analyze a scene situation for the image, the quality of which has been processed for each object. The processor 120 may analyze the scene situation of the image to infer a corresponding environment via analysis of various factors, such as locations at which the objects are located within the image, illuminance of the environment, and color temperature, and may identify whether additional color correction is required. For example, as a result of analyzing the scene environment, a color of an object has been analyzed to be a color of indoor lighting, and an image quality control value has been calculated in response to the color of indoor lighting, but if a surrounding environment is analyzed to be an outdoor environment rather than an indoor environment, there is a high probability that the color of the object is not the indoor lighting color, so that the processor 120 may adjust the image quality control value of the object by lowering a weight.

In operation 675, the processor 120 may calculate a final image quality control value by mixing the image quality control value and weight for each object.

In operation 680, the processor 120 may feed back (or transfer) the final image quality control value to the image processing module 451.

For example, after the image processing module 451 performs image quality processing based on the original data corresponding to a first frame of the image, image quality processing may be performed in consideration of additional factors occurring during ISP processing on the original data via the segmentation information. Accordingly, by analyzing information generated during ISP processing as an additional factor, and performing image quality processing, image correction may be performed with more improved quality compared to the image, the image quality of which is processed based on information obtained by analyzing the original data.

In operation 685, the processor 120 may generate a corrected image by processing the image using the final image quality control value.

In operation 690, the processor 120 may post-process the corrected image.

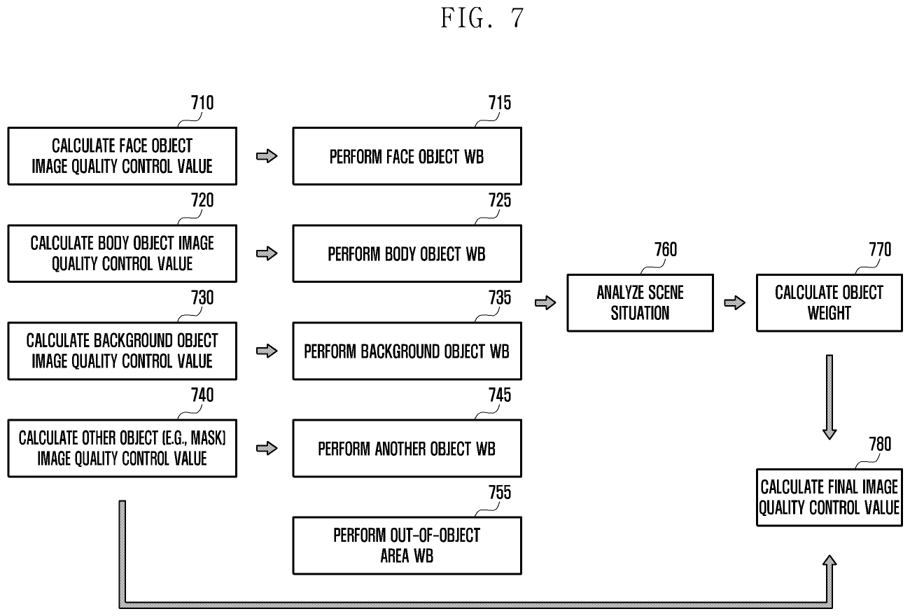

FIG. 7 illustrates an example of an operation of calculating an image quality control value of an object by using segmentation information according to an embodiment.

Referring to FIG. 7, in various embodiments, a processor (e.g., the processor 120 of FIG. 1, the image signal processor 260 of FIG. 2, and the ISP module 450 of FIG. 4) of an electronic device may identify and classify multiple objects in an image based on segmentation information, may calculate an image quality control value for each object area and may perform image quality processing for each object. Image quality processing for each object may be performed individually or in parallel, but is not limited thereto.

As an example of image processing, WB correction is described. The processor 120 may calculate a final image quality control value by performing WB correction for each object.

For example, the processor 120 may identify segmentation areas of a face object, a body object, a background object (e.g., a lighting object) and other objects (e.g., a mask object) within the image based on segmentation information.

In operation 710, the processor 120 may calculate an image quality control value (e.g., a face WB target value) of the face object and may acquire result data by performing WB correction on a segmentation area classified as the face object in operation 715.

In operation 720, the processor 120 may calculate an image quality control value (e.g., a body WB target value) of the body object and may acquire result data by performing WB correction on a segmentation area classified as the body object in operation 725.

In operation 730, the processor 120 may calculate an image quality control value (e.g., a background WB target value) of the background object (e.g., lighting) and may acquire result data by performing WB correction on a segmentation area classified as the background object in operation 735.

In operation 740, the processor 120 may calculate an image quality control value (e.g., a mask WB target value) of another object (e.g., a mask) and may acquire result data by performing WB correction on a segmentation area classified as other object in operation 745.

In operation 750, the processor 120 may acquire result data by performing WB correction on an area other than an object (out-of-object).

The processor 120 may analyze a scene situation of the image based on the result data in operation 760 and may calculate an object weight in operation 770. The processor 120 may determine a weight for each object based on at least one of object brightness information, object color (color temperature) information, object movement information (e.g., speed and movement), object color reliability, distance information, size information, a segmentation ratio and weight information for each object segmentation area within the image.

In operation 780, the processor 120 may calculate a final image quality control value by mixing the image quality control value and the weight for each object.

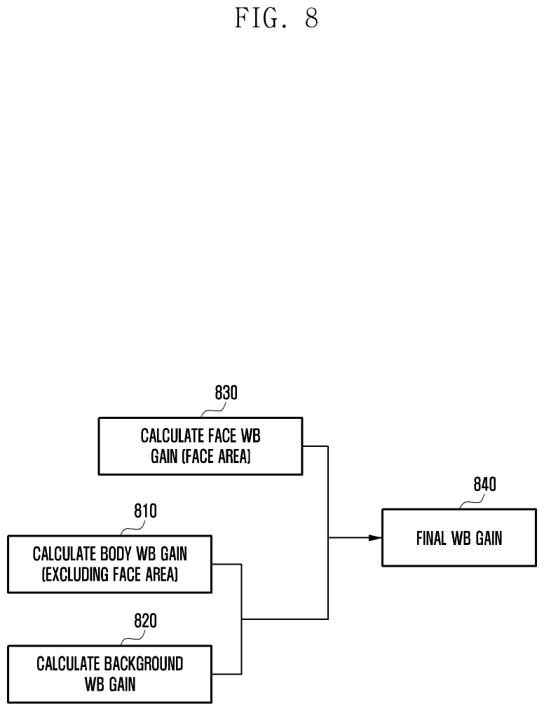

FIG. 8 illustrates an example of an operation of calculating a WB control value by using segmentation information according to an embodiment.

Referring to FIG. 8, according to various embodiments,

A processor (e.g., the processor 120 of FIG. 1, the image signal processor 260 of FIG. 2, and the ISP module 450 of FIG. 4) of an electronic device may map original data and segmentation information to correct WB of objects, may classify a segmentation area for each object and may sequentially mix a weight for each object to derive a final image quality control value.

In a case where an image is classified into a face object, a body object and background object areas, the processor 120 may calculate a body WB gain (body WB gain) (in other words, an image quality control value) for WB correction based on a color of the body object area in operation 810. For example, a WB correction gain (e.g., R gain or B gain) may be calculated based on an average color value of pixels existing in the body area.

In operation 820, the processor 120 may calculate a background WB gain (background WB gain) based on a color of the background object area.

The processor 120 may extract weights that match reliable colors of a body object and a background object via reliability estimation of the body object area and the background object area and may mix the extracted weights by applying the same to the body WB gain and the background WB gain, respectively.

In operation 830, the processor 120 may calculate a face WB gain (face WB gain) based on a color of the face object area. The processor 120 may extract a weight that matches a reliable color of a face object and may apply the extracted weight to the face WB gain (face WB gain).

In operation 840, the processor 120 may calculate a final WB gain (final WB gain) by combining data obtained by mixing the weights with the body WB gain and the background WB gain and data obtained by applying the weight to the face WB gain (face WB gain).

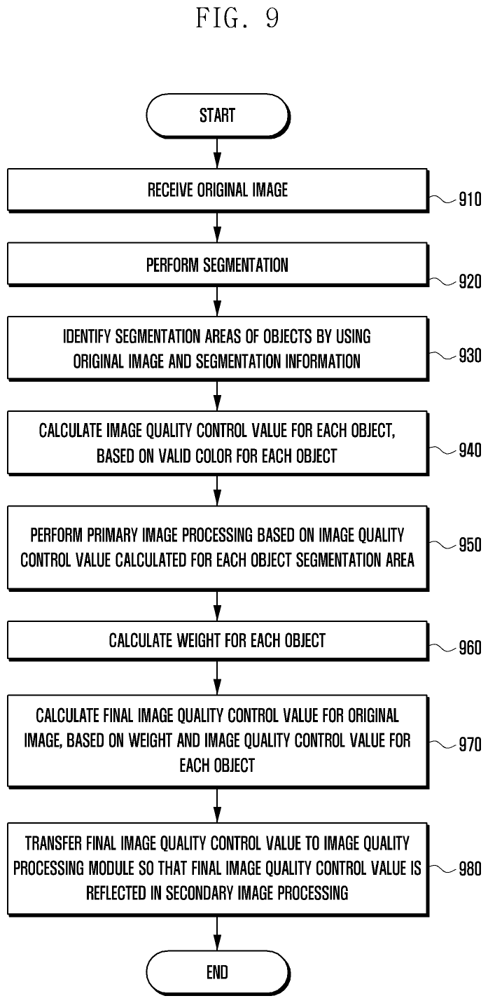

FIG. 9 illustrates a method for improving an image quality according to various embodiments.

Referring to FIG. 9, a processor (e.g., the processor 120 of FIG. 1, the image signal processor 260 of FIG. 2, and the ISP module 450 of FIG. 4) of an electronic device according to various embodiments may receive an original image from a camera in operation 910. The original image (or raw data or raw image data) may include Bayer pattern data or RGB data.

In operation 920, the processor 120 may perform segmentation on the original image to acquire segmentation information.

According to an embodiment, the processor 120 may divide objects in the image (or a frame corresponding to the image) into units of pixels or units of areas and assign attribute values and may configure a segmentation map for recognizing and classifying (or identifying) of the objects. The segmentation information may include object recognition information (or object classification information) included in the image, position information (or pixel coordinate information) of recognized objects, and information on object attributes, and may include all information on the objects.

In operation 930, the processor 120 may identify segmentation areas (or object areas) of the objects by using the original image and the segmentation information.

According to an embodiment, the processor 120 may identify the segmentation areas (or object areas) of the respective objects in the image based on position information for each object.

In operation 940, the processor 120 may calculate an image quality control value for each object based on object colors in the segmentation areas.

According to an embodiment, the processor 120 may analyze whether a recognized object is valid as an image processing object based on the original image and the segmentation information of the image and may estimate the reliability (or color accuracy) of an object color.

According to an embodiment, the processor 120 may convert pixel data of a segmentation area, in which a target object (e.g., a skin object) is located, into color tone values of a hue-saturation-and-value (HSV) color space based on segmentation information of the object recognized in the image and may determine an object color (or color temperature) by identifying distribution of minimum, maximum and average values based on a color histogram.

According to an embodiment, when the object is analyzed as a valid object, the processor 120 may determine the reliability of the object color by comparing color information included in the original data with the object color analyzed via the segmentation information. When compared to the object color in the original image, if the reliability (or color accuracy) of the object color in the segmentation information is greater than or equal to a designated value (or if the reliability is high), the processor 120 may determine the object color of the segmentation information to be the color of the object, and if the object color in the segmentation information has a value smaller than or equal to a designated value (or if the reliability is low), the processor 120 may designate, as the color of the object, an object color acquired by analyzing a similar environment related to a scene of the image or an object color of another similar object in the image.

According to an embodiment, if the reliability of the object color in the segmentation information is between a first value and a second value, the processor 120 may designate the color of the object by mixing the object colors in the segmentation information and the original image.

The processor 120 may calculate an image quality control value for each object, based on object colors in the respective segmentation areas.

According to some embodiments, when different image processing is performed for each object classified based on the segmentation information, the processor 120 may calculate an image quality control value differently in response to image value processing determined for each object.

In operation 950, the processor 120 may perform primary image processing based on the image quality control value calculated for each object segmentation area.

According to an embodiment, the processor 120 may perform image processing by controlling an image processing module (e.g., ISP pipeline). For example, the processor 120 may be perform the primary image processing including a first operation of performing image processing based on an image quality control value of a first object in a first object area, a second operation of performing image processing based on an image quality control value of a second object in a second object area, and a third operation of performing image processing on an out-of-object area other than the first object area and the second object area.

In operation 960, the processor 120 may calculate a weight for each object.

According to an embodiment, the processor 120 may calculate a weight for image processing, based on result data of the primary image processing and the segmentation information.

According to an embodiment, the processor 120 may determine a weight for each object, based on at least one of object brightness information, object color (color temperature) information, object movement information (e.g., speed and movement), object color reliability, distance information, size information, a segmentation ratio, and weight information for each object segmentation area within the image.

In operation 970, the processor 120 may calculate a final image quality control value for the original image, based on the weight and image quality control value for each object.

In operation 980, the processor 120 may transfer (or feed back) the final image quality control value to the image processing module so that the final image quality control value is reflected in secondary image processing.

According to an embodiment, the processor 120 may generate a corrected image by processing the original image using the final image quality control value via the image processing module.

A method for improving an image quality by an electronic device according to various embodiments comprises receiving an original image from a camera, performing image segmentation on the original image to acquire segmentation information, identifying segmentation areas of classified objects in the original image, by using the segmentation information, based on object colors of the segmentation areas, calculating an image quality control value for each object, performing primary image processing based on the calculated image quality control value for each object, calculating a weight for each object by analyzing a primary image processing results, based on the weight and the image quality control value for each object, calculating a final image quality control value for the original image and based on the final image quality control value, performing secondary image processing on the original image to generate a corrected image.

According to some embodiments, the acquiring of the segmentation information further comprises performing image segmentation to classify objects recognized in the original image, and configuring a segmentation map, and based on sensor information acquired from a sensor module, performing object motion estimation to calculate delay data between a segmentation performance time and a time required for image processing in an image processing module, and adjusting the segmentation map based on the delay data.

According to some embodiments, the calculating of the image quality control value for each object comprises determining the object colors according to the segmentation areas of the objects, based on the object colors, determining whether the classified objects are valid as objects for image processing, in case the classified objects are valid as objects for image processing, calculating image quality control values of the respective objects.

According to some embodiments, the calculating of the image quality control value for each object comprises in case an object identified via the segmentation information is valid as an object for image processing, changing, to color space data, pixel data of a segmentation area of the object in the segmentation map, determining a color or color temperature of the object, estimating the reliability of the object color by comparison with a color of an area in which the object is located in the original data.

According to some embodiments, the estimating the reliability of the object color by comparison with a color of an area in which the object is located in the original data in comparison with the object color in the original image comprises determining the color of the segmentation information to be the color of the object in case the reliability of the object color in the segmentation information is equal to or greater than a designated first value, determining the color of the object color by analyzing a similar environment related to a scene of the image or a color of another similar object in the image in case the reliability of the object color in the segmentation information is equal to or smaller than a designated second value, and determining the color of the object by mixing the colors in the segmentation information and the original image in case the reliability of the object color in the segmentation information is between the first value and the second value.

According to some embodiments, the calculating a weight for each object comprises analyzing a scene situation of the image, based on result data of the primary image processing, and adjust the weight according to an analysis result.

According to some embodiments, the calculating a final image quality control value for the original image based on the weight and the image quality control value for each object further comprises calculating an image quality control value differently in response to image processing determined for each object when different image processing is performed for each object classified based on the segmentation information.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a camera; and
a processor comprising an image processing module and a segmentation module configured to generate segmentation information by performing segmentation on an original image acquired via the camera and to transfer the segmentation information to the image processing module,
memory storing instructions, executable by the processor, that cause the electronic device to:
identify segmentation areas of objects in the original image using the original image and the segmentation information;
calculate an image quality control value for each object based on object colors of the segmentation areas;
perform primary image processing based on the calculated image quality control value for each object via the image processing module;
calculate a weight for each object by analyzing primary image processing results;
calculate a final image quality control value for the original image based on the weight and the image quality control value for each object; and
transfer the final image quality control value to the image processing module so that the final image quality control value is reflected in secondary image processing.

2. The electronic device of claim 1, wherein the image processing module comprises image signal pipeline.

3. The electronic device of claim 1, further comprising a sensor module,
wherein the instructions cause segmentation module to:
perform image segmentation to classify the objects recognized in the original image and configure a segmentation map; and
perform object motion estimation to calculate delay data between a segmentation performance time and a time required for image processing in the image processing module based on sensor information acquired from the sensor module and adjust the segmentation map based on the delay data.

4. The electronic device of claim 3, wherein the segmentation map is configured based on original data of the original image acquired from the camera or data obtained by processing the original data.

5. The electronic device of claim 3, wherein the instructions cause the electronic device to:
determine the object colors according to the segmentation areas of the objects;
determine whether an object identified in the image is valid as an object for image processing based on the object colors; and
calculate an image quality control value of the object in case the identified object is valid as an object for image processing.

6. The electronic device of claim 5, wherein the instructions cause the electronic device to:
change pixel data of a segmentation area of the object in the segmentation map to color space data in case an object identified via the segmentation information is valid as an object for image processing;
determine a color or color temperature of the object;
estimate the reliability of the object color by comparison with a color of an area in which the object is located in the original data; and
calculate an image quality control value of the object based on the determined object color by using the reliability.

7. The electronic device of claim 6, wherein the instructions cause the electronic device to:
determine the color of the segmentation information to be the color of the object in comparison with the object color in the original image in case the reliability of the object color in the segmentation information is equal to or greater than a designated first value;
determine the color of the object color by analyzing a similar environment related to a scene of the image or a color of another similar object in the image in case the reliability of the object color in the segmentation information is equal to or smaller than a designated second value; and
determine the color of the object by mixing the colors in the segmentation information and the original image in case the reliability of the object color in the segmentation information is between the first value and the second value.

8. The electronic device of claim 1, wherein the instructions cause the electronic device to perform the primary image processing comprising:
a first operation of image processing on a segmentation area of a first object among the objects;
a second operation of image processing on a segmentation area of a second object; and
a third operation of image processing on an area other than the segmentation areas classified as the objects.

9. The electronic device of claim 1, wherein following the primary image processing, the instructions cause the electronic device to determine a weight for each object based on at least one of object brightness information, object color information, object color temperature information, object movement information, object color reliability, distance information, size information, a segmentation ratio and weight information for each object segmentation area within the image.

10. The electronic device of claim 9, wherein the instructions cause the electronic device to:
analyze a scene situation of the image based on result data of the primary image processing; and
adjust the weight according to an analysis result.

11. The electronic device of claim 1, wherein the instructions cause the electronic device to calculate an image quality control value differently in response to image processing determined for each object, and apply the same to image processing in case different image processing is performed for each object classified based on the segmentation information.

12. The electronic device of claim 1, wherein the instructions cause the electronic device to:
generate a corrected image by performing the secondary image processing based on the final image quality control value; and
post-process the corrected image to either display the same on the display or store the same in a memory.

13. The electronic device of claim 1, wherein the image quality control value comprises at least one of a white balance correction value, a color adjustment value, a color filter correction value, an automatic exposure correction value, a noise adjustment value, a texture adjustment value and a tone curve value.

14. An electronic device comprising:
a camera;
a processor; and
memory storing instructions, executable by the processor, that cause the electronic device to:
identify segmentation areas of objects in an original image based on segmentation information generated by performing segmentation on the original image acquired via the camera;
calculate an image quality control value for each object;
perform primary image processing based on the calculated image quality control value for each object;
calculate a weight for each object by analyzing primary image processing results;
calculate a final image quality control value for the original image based on the weight and the image quality control value for each object; and
transfer the final image quality control value to an image processing module.

15. The electronic device of claim 14, further comprising a segmentation module configured to generate the segmentation information by performing segmentation on an original image acquired via the camera, and a sensor module, wherein the instructions cause the segmentation module to:
perform image segmentation to classify the objects recognized in the original image and configure a segmentation map;
perform object motion estimation to calculate delay data between a segmentation performance time and a time required for image processing based on sensor information acquired from the sensor module and adjust the segmentation map based on the delay data,
wherein:
the segmentation map is configured based on original data of the original image acquired from the camera or data obtained by processing the original data, and
wherein the instructions cause the electronic device to:
determine the object colors according to the segmentation areas of the objects;
determine whether an object identified in the image is valid as an object for image processing based on the object colors; and
calculate an image quality control value of the object in case the identified object is valid as an object for image processing.

16. The electronic device of claim 15, wherein the instructions cause the electronic device to:
change pixel data of a segmentation area of the object in the segmentation map to color space data in case an object identified via the segmentation information is valid as an object for image processing, determine a color or color temperature of the object, estimate the reliability of the object color by comparison with a color of an area in which the object is located in the original data and calculate an image quality control value of the object based on the determined object color by using the reliability, and
determine the color of the segmentation information to be the color of the object in comparison with the object color in the original image in case the reliability of the object color in the segmentation information is equal to or greater than a designated first value, determine the color of the object color by analyzing a similar environment related to a scene of the image or a color of another similar object in the image in case the reliability of the object color in the segmentation information is equal to or smaller than a designated second value and determine the color of the object by mixing the colors in the segmentation information and the original image in case the reliability of the object color in the segmentation information is between the first value and the second value.

17. The electronic device of claim 14, wherein the instructions cause the electronic device to perform the primary image processing comprising:
a first operation of image processing on a segmentation area of a first object among the objects;
a second operation of image processing on a segmentation area of a second object; and
a third operation of image processing on an area other than the segmentation areas classified as the objects.

18. The electronic device of claim 14, wherein following the primary image processing, the instructions cause the electronic device to:
determine a weight for each object based on at least one of object brightness information, object color information, object color temperature information, object movement information, object color reliability, distance information, size information, a segmentation ratio and weight information for each object segmentation area within the image, and
analyze a scene situation of the image based on result data of the primary image processing and adjust the weight according to an analysis result.

19. A method for improving an image quality by an electronic device, the method comprising:
receiving an original image from a camera;
performing image segmentation on the original image to acquire segmentation information;
identifying segmentation areas of classified objects in the original image using the segmentation information;
calculating an image quality control value for each object based on object colors of the segmentation areas;
performing primary image processing based on the calculated image quality control value for each object;
calculating a weight for each object by analyzing primary image processing results;
calculating a final image quality control value for the original image based on the weight and the image quality control value for each object; and
performing secondary image processing on the original image to generate a corrected image based on the final image quality control value.

20. The method of claim 19, wherein the acquiring of the segmentation information further comprises:
performing image segmentation to classify objects recognized in the original image and configuring a segmentation map; and
performing object motion estimation to calculate delay data between a segmentation performance time and a time required for image processing in an image processing module based on sensor information acquired from a sensor module, and adjusting the segmentation map based on the delay data, and
wherein the calculating of the image quality control value for each object comprises:
determining the object colors according to the segmentation areas of the objects;
determining whether the classified objects are valid as objects for image processing based on the object colors; and
calculating image quality control values of the respective objects in case the classified objects are valid as objects for image processing.
